(19) United States
(12) Patent Application Publication
(10) Pub. No.: US 2007/0031544 A1
(43) Pub. Date: Feb. 8, 2007

(54) Container-packaged beverage method for its production and beverage flavor-enhanced method

(76) Inventors: Takayuki Taniguchi, Osaka (JP); Mikha Kono, Osaka (JP); Yasuko Fujiwara, Kyoto (JP); Motoe Fujii, Osaka (JP)

Correspondence Address: DRINKER BIDDLE & REATH (DC), 1500 K STREET, N.W., SUITE 1100, WASHINGTON, DC, 20005-1209, US

(21) Appl. No.: 10/548,958

(22) PCT Filed: Mar. 17, 2004
(86) PCT No.: PCT/JP04/03582

§ 371 Date: Jun. 26, 2006

(30) Foreign Application Priority Data
Mar. 17, 2003 (JP) 2003-072846

(51) Int. Cl. A23B 7/148

(52) U.S. Cl. 426/106

(57) ABSTRACT

The invention relates to a container-packaged beverage, particularly an alcoholic beverage having a headspace of a prescribed size in the container of the container-packaged beveraged, wherein the beverage and a gas, for example air, can be thoroughly mixed in the headspace of the container prior to consumption, so that the consumers themselves can enhance the flavor of the beverage, and a method for production thereof. An enhanced flavor may be imparted to the beverage by mixing the beverage with a gas in the headspace in the container just prior to consumption.

### FIELD OF THE INVENTION

The present invention relates to a novel container-packaged beverage, to a method for its production and to a beverage flavor-enhancing method.

### PRIOR ART

Various beverages such as juices, coffee, tea, milk, cocktails and the like are filled into containers and sold as container-packaged beverages, for consumer convenience. Most container-packaged beverages are provided with slight headspaces in order to prevent spilling during the steps for sealing of the containers, which may involve seaming of cans or molding after filling of paper containers, or on the conveyor systems between filling and closing. However, from the viewpoint of preventing degradation of products after production, it has been considered that the headspace should preferably be as small as possible, and headspaces of container-packaged beverages currently on the market are for the most part about 5% of the container volume.

Various flavor enhancers have been used for the purpose of enhancing the flavor of processed beverages, including container-packaged beverages (see Japanese Patent Public Disclosure No. 2000-245431, Japanese Patent Public Disclosure No. 2000-52331) and such flavor enhancers have been added during beverage production steps, but flavor enhancement cannot be expected after the beverage has been filled. In the case of alcoholic beverages, there have been proposed methods and equipment for enhancing taste by agitation with ultrasonic vibrations of 20-100 kc to separate the alcohol molecule aggregates into individual alcohol molecules, whereby the individual alcohol molecules become surrounded by water molecules (see Japanese Patent Public Disclosure No. HEI 11-9257). However, enhancing the taste of an alcoholic beverage by ultrasonic vibrations requires special equipment and is difficult to achieve.

Addition of antioxidants such as ascorbic acid and a sulfite salt or preservatives such as benzoic acid during production is known as a way of preserving and preventing degradation of produced beverages, but such additives do not enhance flavor.

On the other hand, certain types of beverages, for example, beverages containing fruit pulp, are often shaken just prior to consumption to homogenize the sediment in the beverage container before drinking, but this is not for the purpose of enhancing the flavor of the beverage.

### SUMMARY OF THE INVENTION

The present invention provides a novel container-packaged beverage which offers enhanced flavor, a method for its production and a simple beverage flavor-enhancing method for container-packaged beverages which is not found in the prior art.

The invention further provides container-packaged beverages, and especially alcoholic beverages, which allow the consumers themselves to enhance the flavors of the beverages just before consumption.

### BRIEF DESCRIPTION OF THE DRAWINGS

FIG. 1 is a graph showing the headspace volume proportions and changes in organoleptic evaluations before and after mixing, for the cocktails produced in the preparation example.

FIG. 2 is a graph showing the headspace volume proportions and changes in dissolved oxygen contents by mixing, for the cocktails produced in the preparation example.

FIG. 3 is a graph showing the headspace volume proportions and changes in aromatic component concentrations in the headspaces before and after mixing, for the cocktails produced in the preparation example.

FIG. 4 is a graph showing the headspace volume proportions and changes in absolute aromatic component contents in the headspaces before and after mixing, for the cocktails produced in the preparation example.

FIG. 5 is a graph showing the headspace volume proportions and changes in organoleptic evaluations before and after mixing, for a commercially available orange juice product.

### DETAILED DESCRIPTION

The invention provides a beverage in the form of a container-packaged beverage having been packaged in a container in such a manner as to provide a headspace for mixing of the beverage with a gas.

The container-packaged beverage of the invention is contained in a container with a headspace of a prescribed size, and the beverage is thoroughly mixed with a gas (for example, air) in the headspace of the container prior to consumption, so that consumers themselves can enhance the flavor of the beverage.

The invention further provides a method for production of a container-packaged beverage, characterized by filling a container with a beverage in such a manner as to provide a headspace in the container for mixing of the beverage with a gas.

The invention still further provides a beverage flavor-enhancing method, whereby a beverage in a container is mixed with a gas in the headspace.

### PREFERRED MODE OF THE INVENTION

Container-packaged beverages to be used for the invention include cold beverages (for example, juice beverages, sports drinks (isotonic drinks), etc.), teas (for example, green tea, black tea, Chinese tea, etc.), coffee, cocoa, juices, milk beverages, alcoholic beverages (for example, low alcoholic beverages such as cocktails, distilled liquors (Japanese spirits, whiskey, spirits (vodka, gin, rum, tequila)), brewed liquors (sake, wine), liqueurs, etc.) and other products listed in the Standard Industrial Classification for Japan (Management and Coordination Agency). Preferred beverages are generally beverages which are filled into containers as adequately homogeneous liquids at the time of production, and not of the types which are shaken by consumers before consumption in order to homogenize the components. For beverages containing carbon dioxide gas, although they are normally associated with effusion by shaking, the flavor enhancing method of the invention is applicable to low carbonated beverages where the carbon dioxide generated by shaking does not disturb the beverage.

A container-packaged beverage according to the invention may also be a mixed beverage comprising two or more different beverages. For example, a citrus beverage may be mixed with another beverage such as an alcoholic beverage. Citrus beverages contain limonene and therefore when mixed with other beverages they can yield beverages according to the invention with notably enhanced flavor.

When a container-packaged beverage of the invention is an alcohol-containing beverage, there are no particular restrictions as to the base liquor used for production of the beverage, and it may be a distilled liquor such as Japanese spirits, whiskey or other spirits, a brewed liquor such as sake or wine, or a liqueur.

A container-packaged beverage of the invention is preferably embodied in an alcoholic beverage such as a cocktail, and particularly preferred are alcoholic beverages which are mixtures of fruit juice with distilled liquor or liqueur. The container-packaged beverage of the invention most suitably takes form in low alcoholic beverages having an alcohol content of no greater than 12%, especially less than 9% and more preferably no greater than 6%.

The gas in the headspace, which is to be mixed with the beverage may be any gas which can enhance the flavor of the beverage by mixing, and examples thereof are oxygen, carbon dioxide and air. In the case of a beverage which is filled and shipped with an inert gas being charged in the headspace to maintain the pressure in the container, the gas in the headspace to be mixed with the beverage is defined to be the air which replaces the inert gas when the beverage container is opened. Throughout the present specification, “inert gas” refers to a gas such as nitrogen gas which is sometimes filled into the packaging or container of a food or beverage product along with the food or beverage which is susceptible to quality deterioration when in contact with air for long periods.

Possible reasons for the flavor enhancing effect of the invention are that the beverage components associate with the gas in the headspace to produce a more rounded flavor, and that the aromatic components in the beverage migrate into the headspace of the container to produce desirable odors. Consequently, the headspace according to the invention may be a sufficient size which allows the flavor of the beverage to be enhanced by mixing of the container-packaged beverage, and the size may be appropriately determined in consideration of preventing deterioration of the product and increasing the product value. For example, the headspace is preferably at least 5%, preferably at least 10% and more preferably at least 15% of the volume of the container.

The method for mixing the beverage in the container with the gas in the headspace is not particularly restricted so long as both are mixed. However, in order to prevent escape of the aromatic components produced in the headspace, preferably the container is capped, held with the hands and shaken back and forth, right and left, or up and down. There are no particular restrictions on the time of mixing to enhance the flavor, but a certain enhancement of flavor will appear upon shaking for a time sufficient to accomplish thorough mixing. A time of 10-30 seconds, for example, may be established. The mixing may be effected at any time without limitation as long as it is prior to consumption of the beverage, and even in cases where the flavor enhancing effect achieved by mixing will fade as times passes with the container being left open, the flavor can be re-enhanced by re-mixing.

Various types of beverage containers have been developed such as cans, PET bottles, glass bottles, cartons and the like, and these may be used as appropriate. In the case of a beverage having an inert gas filled into the headspace, splashing of the beverage by mixing should be avoided by first releasing the pressure in the can, etc. to replace the gas with air before mixing, and therefore the stopper or cap of the container must be freely reclosable. However, the present invention is not limited to such types of container.

One embodiment of the container-packaged beverage of the invention is a beverage product which comprises a container, a beverage preferably in the form of a homogeneous liquid filled in the container, a gas in the headspace formed above the beverage in the container, and a reclosable stopper or cap capable of producing an airtight state in the container, wherein just prior to consumption, the gas in the headspace and the beverage are thoroughly mixed to allow enhancement of the flavor of the beverage.

A container with a thinly tapered top will not only facilitate mixing of the beverage with the gas in the headspace, but can also create the feeling of shaking with a shaker, thereby raising the level of enjoyment of the beverage. The container may be metallic or the container exterior may have a metal luster, to more closely imitate a shaker.

The stopper or cap of the container may be of any type which can maintain airtightness in the container and which can be freely attached and removed, but a screw cap is preferred. The beverage and the gas capable of producing a flavor upon being mixed therewith are filled into the headspace of the container. Alternatively, an inert gas may be filled into the container at the time of shipping of the beverage, after which the inert gas is replaced with air when the cap is opened just prior to consumption, and the stopper or cap is reclosed to mix the beverage with the air in the headspace for enhancement of the flavor of the beverage.

A beverage according to the invention may also appropriately contain various additives or raw materials commonly used for production of beverages. For example, there may be used food additives such as flavoring agents and acidulants, or raw materials generally consumed as foods such as saccharides, fruit juices, dairy components and the like, among which specifically there may be mentioned sugars, isomerized sugars, dextrin, citric acid, lemon juice, grapefruit juice, orange juice, fermented milk, cow's milk, concentrated milk and the like.

An aromatic used is preferably one having an effect of releasing a desirable aroma in the headspace upon mixing with the gas in the headspace.

These additives and raw materials may be added as appropriate for the type of beverage, and for example, saccharides are preferably added at about 0-15 wt % per beverage, aromatics are preferably added at about 0-2 wt % per beverage, and acidulants are preferably added at about 0-2 wt % per beverage.

According to the present invention it is possible for beverage consumers themselves to enhance the flavors of beverages by a very simple method. A much greater degree of design freedom is therefore possible for flavors of container-packaged beverages.

### EXAMPLES

The present invention will now be explained in greater detail through examples, with the understanding that they are in no way limitative on the scope of the invention.

### Preparation Example

Commercially available orange juice and vodka were mixed in a proportion of 3:1 (alcohol component: approximately 10 v/v %) to prepare a cocktail, and nitrogen gas was bubbled through at 5° C. for deairing. After deairing, the mixture was filled into a stopper-equipped bottle until the headspace volume became 5%, 10%, 15% or 30% of the container volume (approximately 133 mL for organoleptic evaluation and measurement of dissolved oxygen, and approximately 126 mL for measurement of aromatic components). In each test in Examples 1-3, comparison was made between the case where the evaluation was made directly (hereinafter “before mixing”) and the case where the evaluation was made after mixing of the beverage with the air in the headspace (hereinafter, “after mixing”).

### Example 1 Organoleptic Test

The cocktails filled into containers by the method described above were subjected to an organoleptic evaluation by a panel of specialists. The mixing was performed by vigorously shaking for one minute by hand immediately before consumption. The four evaluated parameters were “aroma strength”, “aroma balance”, “mildness” and “flavor balance”, and each beverage was evaluated by checking an evaluation box from 0-6 points, with the 5% headspace volume sample before mixing as a control (3 points).

Results

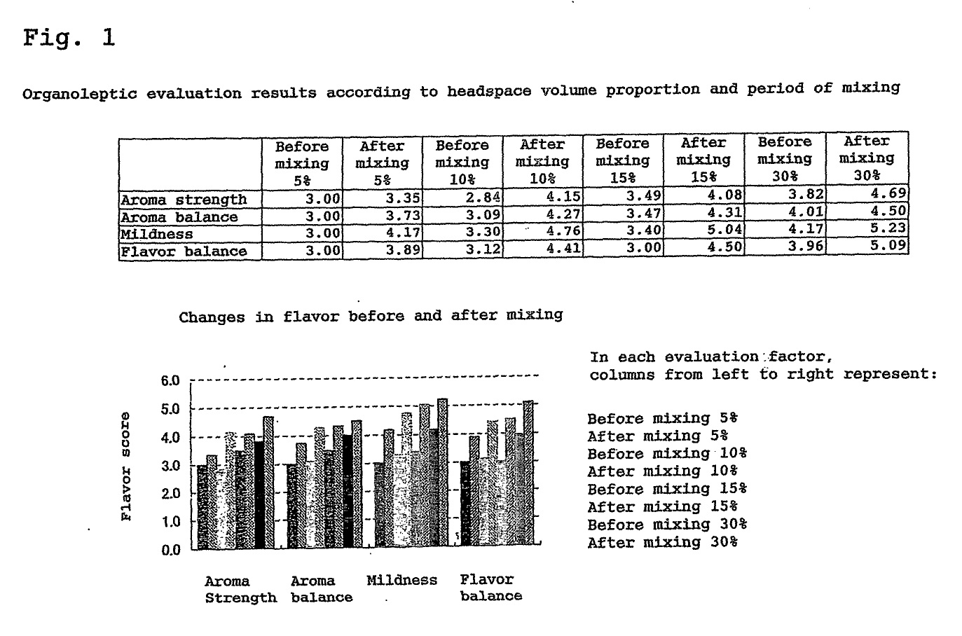

The organoleptic evaluation points for all of the parameters were all higher after mixing than before mixing. Also, the organoleptic evaluation scores were higher with increased headspace volume (FIG. 1). As a result of variance analysis with the organoleptic scores as the characteristic values, the headspace effect and mixing effect were found to be significant with a significance level of 1% for all of the parameters, except for the evaluation scores for “aroma balance” which were not significant with respect to the headspace volume.

This test demonstrated that an increased headspace volume of the container-packaged beverage and/or mixing resulted in enhanced flavor.

TABLE 1
Results of two-way variance analysis of organoleptic scores

| Evaluation Factor | Headspace effect | Mixing effect |
|---|---|---|
| Aroma strength | ** | ** |
| Aroma balance | no significant | ** |
| | difference | |
| Mildness | ** | ** |
| Flavor balance | ** | ** |

*: 5% significance
**: 1% significance

### Example 2 Analysis of Dissolved Oxygen

Method

Cocktails filled into containers by the method described above (4 levels: headspace volumes of 5%, 10%, 15%, 30%) were measured for dissolved oxygen before and after mixing, using a dissolved oxygen meter by Orbisphere Laboratories. The mixing was carried out for 2 minutes using a shaker device by YAMATO.

Results

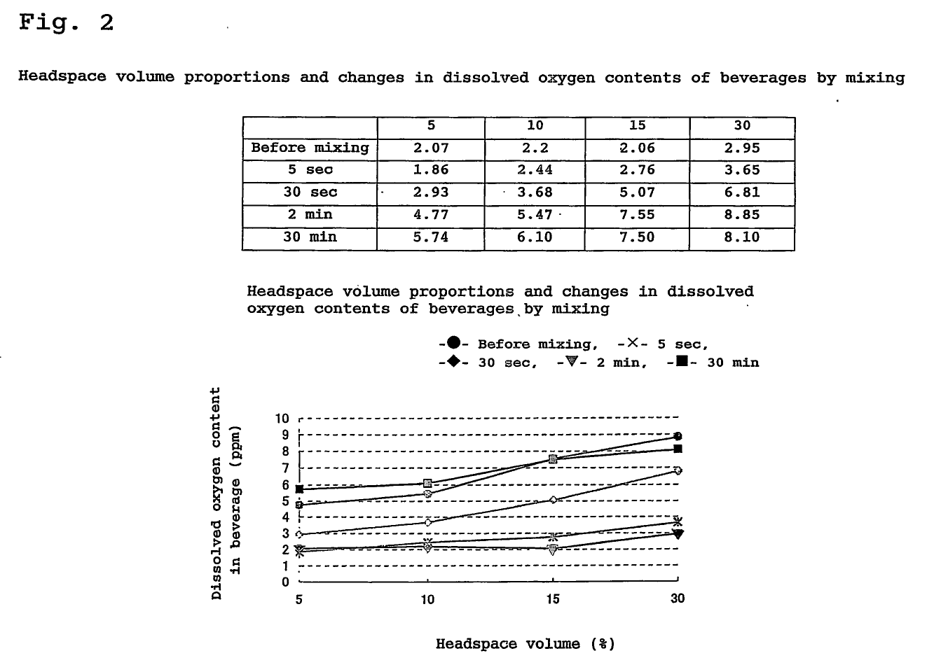

An increased headspace volume resulted in an elevated dissolved oxygen content. The mixing time also showed a similar tendency, but no significant increase was found beyond 2 minutes, thus indicating saturation (FIG. 2).

### Example 3 Analysis of Aromatic Components

Method

The headspace gas of a cocktail filled into a container by the method described above was sampled with a gas-tight syringe, and a gas chromatography apparatus by Shimazu Corp. was used for analysis of the aromatic components. Mixing was carried out for 2 minutes by hand just before analysis.

Results

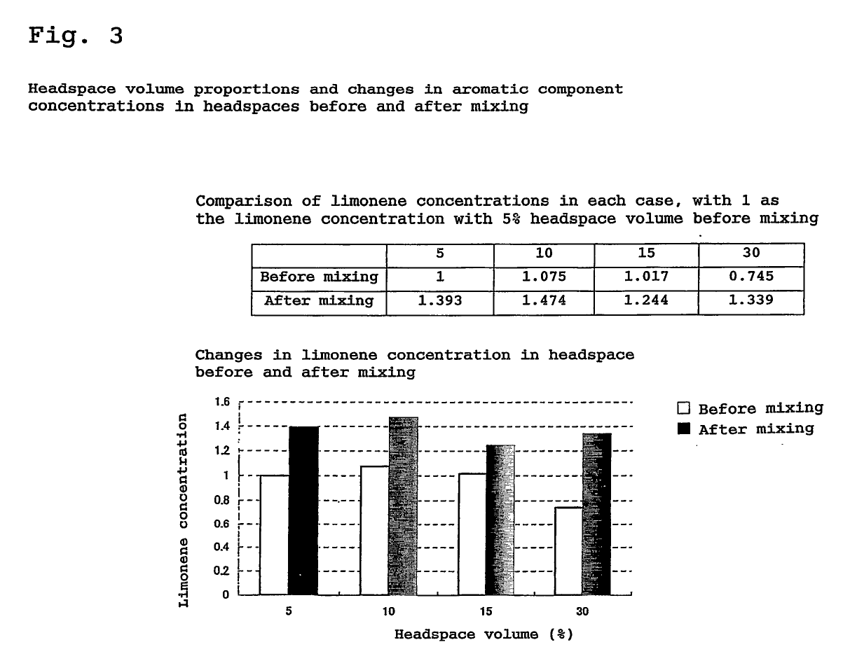

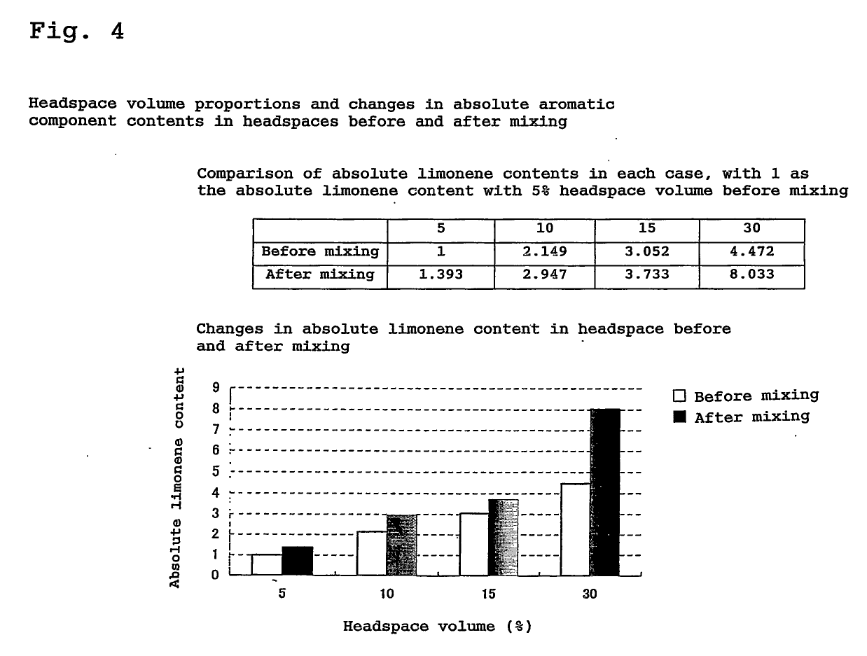

The aromatic components in the headspace gas samples were analyzed based on limonene as a representative citrus component. The limonene concentration was increased by mixing in all of the headspace gas samples (FIG. 3). Also, the absolute content of the aromatic components in the headspace gas samples were found to be greater with larger headspace volumes, indicating that the absolute content is greater with larger headspace volume (FIG. 4).

These results indicated that mixing of a beverage in a container with a gas in the headspace increases the absolute content of aromatic components in the headspace, and further that the mixing also increases the dissolved oxygen content of the beverage to alter the physical properties such as the cluster structure of the constituent components of the beverage, thereby producing a greater mildness and an enhancement of the flavor.

### Example 4

Examples of compositions for an orange-flavored soft beverage and low alcoholic beverage are shown in Table 2. The raw materials were mixed to homogeneity and filled to 290 ml each in 340 ml volume containers. Liquid nitrogen was added dropwise to drive out the air in the headspace, and the caps were immediately closed.

TABLE 2
Compositions of orange-flavored
soft beverage and low alcoholic beverage

| | | Soft | Low alcohol |
|---|---|---|---|
| | | beverage | beverage |
| Vodka | (L) | — | 84.8 |
| (59 v/v %) | | | |
| Orange juice | (Kg) | 20.0 | 5.0 |
| Fructose/glucose solution | (Kg) | 132.3 | 132.3 |
| Citric acid | (Kg) | 8.8 | 8.8 |
| Ascorbic acid | (Kg) | 0.3 | — |
| Orange flavor | (L) | 2.0 | 2.0 |
| Added water | (L) | q.s. | q.s. |
| Total | (L) | 1000.0 | 1000.0 |

### Example 5

A beverage with the following composition was produced and packaged in the same manner as Example 4.

TABLE 3

| | | Coffee beverage |
|---|---|---|
| Coffee extract | (Kg) | 550.0 |
| Coffee flavor | (L) | 1.0 |
| Granular sugar | (Kg) | 65 |
| Milk | (L) | 90 |
| Emulsifier | (Kg) | 0.7 |
| Added water | (L) | q.s. |
| Total | (L) | 1000 |

TABLE 4

| | | Tea beverage |
|---|---|---|
| Tea extract | (Kg) | 900.0 |
| Ascorbic acid | (Kg) | 0.3 |
| Added water | (L) | q.s. |
| Total | (L) | 1000 |

TABLE 5

| | | Sports drink |
|---|---|---|
| | | (Isotonic drink) |
| Granulated sugar | (Kg) | 45.0 |
| Citric acid | (Kg) | 1.5 |
| Ascorbic acid | (Kg) | 0.1 |
| Potassium chloride | (Kg) | 0.5 |
| Calcium lactate | (Kg) | 0.2 |
| Flavor A | (L) | 0.3 |
| Flavor B | (L) | 0.5 |
| Flavor C | (L) | 1.0 |
| Added water | (L) | q.s. |
| Total | (L) | 1000 |

### Example 6

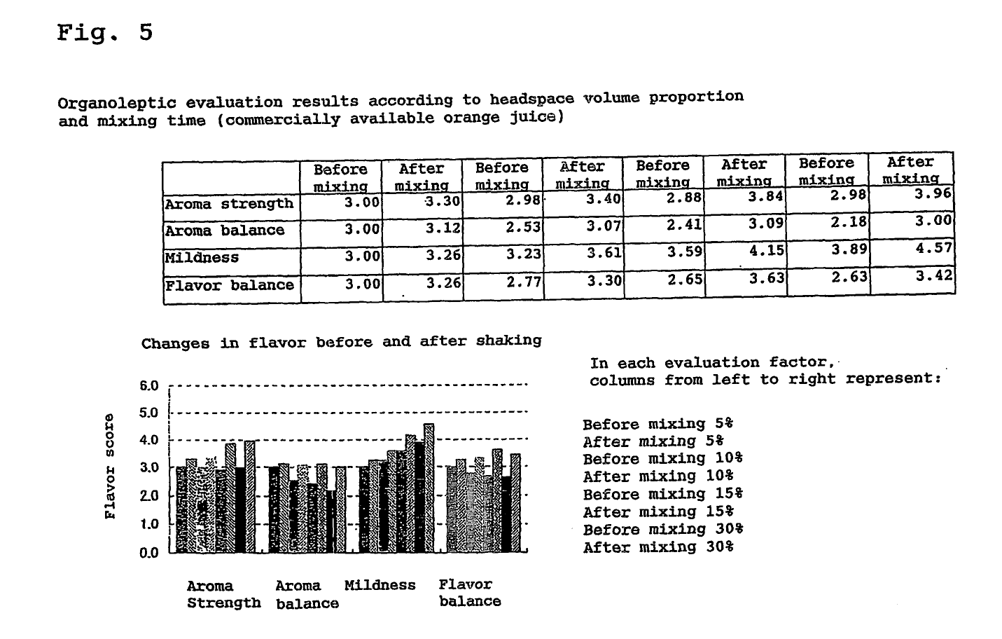

Commercially available orange juice was used for an organoleptic evaluation in the same manner as Example 1. The results are shown in FIG. 5. Overall, the organoleptic evaluation scores were higher after mixing than before mixing, and increasing the headspace volume also resulted in higher organoleptic evaluation scores.

1. A container-packaged beverage wherein the beverage is packaged in a container in such a manner as to provide a headspace for mixing of the beverage with a gas.

2. A container-packaged beverage according to claim 1, which has a headspace of at least 5% of the volume of the container.

3. A container-packaged beverage according to claim 1, which has a headspace of at least 10% of the volume of the container.

4. A container-packaged beverage according to claim 1, wherein said beverage is an alcoholic beverage.

5. A container-packaged beverage according to claim 4, wherein said alcoholic beverage is a low-alcoholic beverage.

6. A container-packaged beverage according to claim 1, wherein said beverage is not a carbonated beverage.

7. A container-packaged beverage according to claim 1, wherein said beverage comprises a mixture of two or more different beverages.

8. A container-packaged beverage according to claim 7, wherein at least one of the mixed beverages is a citrus beverage.

9. A container-packaged beverage according to claim 1, wherein the container is a sealable container having a stopper or cap, the gas in the headspace is an inert gas, and wherein after the stopper or cap is opened, air in the headspace, which has replaced said inert gas can be mixed with the beverage prior to consumption.

10. A container-packaged beverage according to claim 9, which is filled into a container having a thinly tapered top.

11. A method for production of a container-packaged beverage, characterized by filling a container with a beverage in such a manner as to provide a headspace in the container for mixing of the beverage with a gas.

12. A method for production of a container-packaged beverage according to claim 11, wherein a headspace of 5% of the volume of the container is provided.

13. A method for production of a container-packaged beverage according to claim 11, wherein a headspace of 10% of the volume of the container is provided.

14. A method for production of a container-packaged beverage according to claim 11, wherein said beverage is an alcoholic beverage.

15. A method for production of a container-packaged beverage according to claim 14, wherein said alcoholic beverage is a low-alcoholic beverage.

16. A method for production of a container-packaged beverage according to claim 11, wherein said beverage is not a carbonated beverage.

17. A method for production of a container-packaged beverage according to claim 11, wherein said beverage comprises a mixture of two or more different beverages.

18. A method for production of a container-packaged beverage according to claim 17, wherein at least one of the mixed beverages is a citrus beverage.

19. A method for production of a container-packaged beverage according to claim 11
wherein the beverage is one filled in a sealable container having a stopper or cap,
wherein the method comprises filling a beverage into said container in such a manner as to provide a headspace in the container adapted to mix the beverage with the air by opening and reclosing of the stopper or cap prior to consumption;
replacing the gas in the headspace with an inert gas; and
closing the stopper or cap.

20. A beverage flavor-enhancing method, whereby a beverage is packaged in a container in such a manner as to provide a headspace, and the beverage is mixed with a gas in the headspace by shaking prior to consumption.

21. A beverage flavor-enhancing method according to claim 20, wherein the headspace is at least 5% of the volume of the container.

22. A beverage flavor-enhancing method according to claim 20, wherein the headspace is at least 10% of the volume of the container.

23. A beverage flavor-enhancing method according to claim 20, wherein said beverage is an alcoholic beverage.

24. A beverage flavor-enhancing method according to claim 23, wherein said alcoholic beverage is a low-alcoholic beverage.

25. A beverage flavor-enhancing method according to claim 20, wherein said beverage is not a carbonated beverage.

26. A beverage flavor-enhancing method according to claim 20, wherein said beverage comprises a mixture of two or more different beverages.

27. A beverage flavor-enhancing method according to claim 26, wherein at least one of the mixed beverages is a citrus beverage.

28. A beverage flavor-enhancing method according to claim 20, wherein the container is a sealable container having a stopper or cap, and wherein after the stopper is opened, the air in the headspace which has replaced the inert gas in the headspace can be mixed with the beverage.
